(19) United States
(12) Patent Application Publication
(10) Pub. No.: US 2005/0165974 A1
(43) Pub. Date: Jul. 28, 2005

(54) Computer apparatus and computer system

(75) Inventor: Takahiro Tanioka, Tokyo (JP)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 11/038,133

(22) Filed: Jan. 21, 2005

(30) Foreign Application Priority Data
Jan. 23, 2004 (JP) 2004-015420

(51) Int. Cl. G06F 3/00

(52) U.S. Cl. 710/1

(57) ABSTRACT

A memory controller has a link monitoring circuit for detecting a communication cutoff between the memory controller and an I/O controller, and an error reply generating circuit for generating an error reply for a transaction being processed when the communication cutoff is detected. When the I/O controller is disconnected due to a fault, the memory controller, rather than the I/O controller, generates an error reply, for a transaction being processed which is addressed to an I/O device governed by the I/O controller, and sends the error reply to a processor as a source for issuing the transaction.

### BACKGROUND OF THE INVENTION

1. Field of the Invention

The present invention relates to a computer apparatus and a computer system which have a processor, a main memory device, a plurality of peripheral units, and a memory controller and an I/O controller for connecting those components.

2. Description of the Related Art

FIG. 1 of the accompanying drawings shows an arrangement of a computer apparatus as background art of the present invention.

As shown in FIG. 1, the computer apparatus is a multiprocessor system having a plurality of (eight in FIG. 8) processors that are divided into units referred to as cells (first cell 1, second cell 2). First cell 1 comprises four CPUs 11 through 14 connected to processor bus (hereinafter referred to as FSB) 15, main memory device 17, and memory controller (hereinafter referred to as MMC) 16 connected to FSB 15. Second cell 2 comprises four CPUs 21 through 24 connected to FSB 25, main memory device 27, and MMC 26 connected to FSB 25. Various peripheral devices (a keyboard, a mouse, a printer, etc.: hereinafter referred to as I/O devices) that are commonly used by processors (CPUs) of cells that are connectable to PCI buses 31, 32 are connected to MMC 16 of first cell 1 by I/O controller (hereinafter referred to as IOC) 3. Similarly, various I/O devices that are commonly used by processors (CPUs) of cells that are connectable to PCI buses 41, 42 are connected to MMC 26 of second cell 2 by I/O controller 4. The number of cells that make up the computer apparatus, the number of IOCs, and the numbers of processors, main memory devices, and MMCs of each of the cells are not limited to the example shown in FIG. 1, but may be of any values. Each I/O device may be connected to the IOC by an I/O bus comprising a serial bus or the like, rather than the PCI buses.

MMCs 16, 26 are units each comprising one or more LSI (Large Scale Integration) circuits depending on the scale and arrangement of the computer apparatus, for performing a routing process on transactions received from CPUs and I/O devices through FSBs 15,16 and IOCs 3, 4.

MMC 16 has an interface for FSB 15, an interface for a memory controller (not shown) which controls access to main memory device 17, an interface for IOC 3, and an interface for the MMC of another cell (second cell 2 in FIG. 1). Similarly, MMC 26 has an interface for FSB 25, an interface for a memory controller (not shown) which controls access to main memory device 27, an interface for IOC 4, and an interface for the MMC of another cell (first cell 1 in FIG. 1). In the art of personal computers, an LSI or a unit having a function corresponding to MMCs 16, 26 is occasionally called a north bridge.

IOC 3 has an interface for MMC 16, an interface (PCI bus controller) for PCI buses 31, 32 connected to and governed by IOC 3, and a function to route transactions sent and received between MMC 16 and PCI buses 31, 32. Similarly, IOC 4 has an interface for MMC 26, an interface (PCI bus controller) for PCI buses 41, 42 connected to and governed by IOC 4, and a function to route transactions sent and received between MMC 26 and PCI buses 41, 42. Generally, IOCs 3, 4 have an interface and an interrupt controller for various I/O devices including a keyboard, a mouse, a printer, etc. In the art of personal computers, an LSI or a unit having a function corresponding to IOCs 3, 4 is occasionally called a south bridge.

The conventional MMCs and IOCs of the computer apparatus shown in FIG. 1 will be described below with reference to FIGS. 2 and 3 of the accompanying drawings.

FIG. 2 is a block diagram of an arrangement of a conventional memory controller for use in the computer apparatus shown in FIG. 1, and FIG. 3 is a block diagram of an arrangement of a conventional I/O controller for use in the computer apparatus shown in FIG. 1. Specifically, FIG. 2 shows a conventional arrangement of MMC 16 shown in FIG. 1, which is the same as the arrangement of MMC 26, and FIG. 3 shows a conventional arrangement of IOC 3 shown in FIG. 1, which is the same as the arrangement of IOC 4.

As shown in FIG. 2, conventional MMC 16 has FSB_I/F 1601 as an interface with FSB 15, memory I/F 1607 as an interface for a memory controller for controlling access to main memory device 17, IOC_I/F 1609 as an interface for IOC 3, MMC_I/F 1610 as an interface for the MMC of another cell, control circuit 1606 for performing a routing process on transactions sent and received between I/Fs, cache tag 1602 for storing copies of the tags of store-in caches in the CPUs, and TX management table 1603 for storing header information, etc. corresponding to transactions that need to be replied.

MMC 16 shown in FIG. 2 is configured on the basis of general MESI (Modified Exclusive Shared and Invalid) protocol for process of controlling store-in caches in the CPUs. However, a cache protocol is optimally set depending on the configuration of the store-in caches, and is not limited to the above protocol.

As shown in FIG. 3, conventional IOC 3 has MMC_I/F 301 as an interface for MMC 16, PCI_I/F 303, 304 as controllers for I/O buses (PCI buses 31, 32), and a control circuit 302 for performing a routing process on transactions sent and received between I/Fs.

Operation of the computer apparatus having the conventional MMCs and IOCs shown in FIGS. 2 and 3 will be described below.

(1) Processor reading data from memory (accessing memory in its own cell):

For CPU 11 to read data from main memory device 17 in its own cell, for example, a memory reading transaction issued by CPU 11 is sent through FSB 15 to MMC 16. According to the memory reading transaction received from CPU 11, MMC 16 performs a process of reading data from a particular address in main memory device 17. At this time, to maintain cache coherency with the other cell, MMC 16 updates cache tag 1602 according to the MESI protocol, and simultaneously instructs the MMC in the other cell through MMC_I/F 1610 to update the cache tag in the MMC in the other cell. If necessary, writeback from the store-in cache in the other CPU is performed. Coherency control for a cache system according to the MESI protocol is well known to those skilled in the art, and will not be described in detail below. An arrangement for holding copies of the tags of store-in caches in cells for maintaining cache coherency in a plurality of cells is illustrated in Japanese laid-open patent publication No. 11-15734, for example.

When MMC 16 routes a transaction that requires a reply from a transmission destination, such as a memory reading transaction, MMC 16 registers the ID code of a CPU as a transaction issuance source, a readout address, etc. as entries corresponding to the transaction in TX management table 1603. The entries registered in TX management table 1603 are held herein until a reply corresponding to the transaction is returned. While the entries are being registered in TX management table 1603, i.e., while the transaction is being processed, MMC 16 holds a routine process for a transaction issued from another requester, such as a CPU or an IOC, thereby ensuring transaction consistency.

Data that is read from main memory device 17 according to the memory reading transaction is sent through MMC 16 and FSB 15 to CPU 11 which is the transaction issuance source. The entries corresponding to the memory reading transaction, which have been registered in TX management table 1603, are deleted by control circuit 1606 when a reply from main memory device 17 is returned.

(2) Processor reading data from memory (accessing memory in another cell):

For CPU 11 to read data from main memory device 27 in the other cell, for example, a memory reading transaction issued by CPU 11 is sent through FSB 15 and MMC 16 to MMC 26. According to the memory reading transaction received from CPU 11, MMC 26 performs a process of reading data from a particular address in main memory device 27.

As with the above process (1), at the same time that the transaction is transferred from MMC 16 to MMC 26, cache tags of MMCs 16, 26 are updated, and entries are registered in TX management table 1603. Data that is read from main memory device 27 is sent through MMCs, 26,16 and FSB 15 to CPU 11.

(3) Processor writing data in memory:

For CPU 11 to write data in main memory device 17 in its own cell, for example, CPU 11 issues a memory writing transaction including write data. The memory writing transaction and the write data issued from CPU 11 are sent through FSB 15 to MMC 16. According to the memory writing transaction received from CPU 11, MMC 16 performs a process of writing the write data at predetermined addresses in memory device 17. At this time, as with the process of reading data, MMC 16 updates cache tag 1602 according to the MESI protocol, and simultaneously instructs the MMC in the other cell through MMC_I/F 1610 to update the cache tag in the MMC in the other cell.

Data can also be written in the main memory device of the other cell according to the same process as described above. In this case, write data sent from CPU 1 1, for example, is transferred through FSB 15, MMC 16, and MMC 26, and written in main memory device 27.

(4) Processor reading data from I/O device:

In the computer apparatus shown in FIG. 1, a CPU can directly access the various I/O devices, e.g., accessing an I/O space or a memory-mapped I/O space. When I/O devices are thus accessed, any store-in caches are bypassed, and hence the above cache coherency control is not required. However, entries need to be registered in and deleted from TX management table 1603 in the same sequence as with the above process of reading data from main memory devices 17, 27.

For CPU 11 to read data from an I/O device governed by its own cell, for example, a reading transaction issued from CPU 11 is sent through MMC 16 to IOC 3. IOC 3 receives the reading transaction through MMC_I/F 301, and control circuit 302 thereof routes the reading transaction to a PCI bus to which the I/O device is connected as a transmission destination.

If the I/O device as the transmission destination is connected to PCI bus 31, then IOC 3 converts the reading transaction received by PCI_I/F 303 into a PCI bus transaction and sends the PCI bus transaction through PCI bus 31 to the I/O device as the transmission destination. Thereafter, a reply from the I/O device is returned through PCI bus 31 to IOC 3. The reply is transmitted from IOC 3 through MMC 16 and FSB 15 to CPU 11 which is the transaction issuance source. CPU 11 can read data from an I/O device governed by the other cell in the same process as described above.

For example, if a reading transaction sent from IOC 3 to PCI bus 31 for an I/O device fails to reach an I/O device due to a PCI bus error such as a master abort or the like, then control circuit 302 of IOC 3 returns an error reply, rather than an ordinary reading reply, through MMC 16 to CPU 11. The error reply is a special reply transaction for posting to the processor that a transaction has not been finished properly.

Upon receipt of the error reply, CPU 11 recognizes that the reading transaction for the I/O device has not been finished properly, and performs a process according to a predetermined fault processing program or the like for processing the fault.

(5) Processor writing data in I/O device:

There are two types of transactions for writing data from a processor into an I/O device. They are a Deferred writing transaction wherein a succeeding transaction is held until CPU 11 receives a reply indicating that the writing of data into an I/O device is completed, and a Posted writing transaction where the writing of data into an I/O device is regarded as being completed at the time the transaction is sent out.

For CPU 11 to write data in an I/O device governed by its own cell, for example, a writing transaction issued from CPU 11 is sent through MMC 16 to IOC 3. If a Deferred writing transaction is issued from CPU 11, then MMC 16 registers entries in and deleted entries from TX management table 1603 in the same sequence as with the process of reading data. This process is dispensed with if a Posted writing transaction is issued from CPU 11.

Upon receipt of the Deferred writing transaction from MMC_I/F 301, control circuit 302 of IOC 3 routes the Deferred writing transaction to a PCI bus to which the I/O device is connected as a transmission destination.

If the I/O device to which the data is to be written is connected to PCI bus 31, then IOC 3 converts the Deferred writing transaction received by PCI_I/F 303 into a PCI bus transaction and sends the PCI bus transaction through PCI bus 31 to the I/O device. When the transmission of the Deferred writing transaction to PCI bus 31 is completed, control circuit 302 of IOC 3 returns a reply to CPU 11 which is the transaction issuance source. CPU 11 holds a succeeding transaction until the reply is returned thereto.

In the event that the transaction sent from IOC 3 to PCI bus 31 fails to reach the I/O device, control circuit 302 of IOC 3 returns an error reply, rather than an ordinary writing reply, through MMC 16 to CPU 11.

Upon receipt of the error reply, CPU 11 recognizes that the Deferred writing transaction for the I/O device has not been finished properly, and performs a process according to a predetermined fault processing program or the like for processing the fault.

If CPU 11 issues a Posted writing transaction, then CPU 11 regards the writing of data into an I/O device as being completed at the time the transaction is sent out, and can successively issue a next transaction. When MMC 16 receives the Posted writing transaction, MMC 16 routes the Posted writing transaction to an I/O device to which the data is to be written. The processing sequence is finished when the transmission of the transaction to the PCI bus is completed.

(6) I/O device reading data from memory:

In the conventional computer apparatus shown in FIG. 1, an I/O device can access a main memory device in each of the cells.

For an I/O device governed by PCI bus 31 to read data from main memory device 17, for example, a reading transaction issued from the I/O device to PCI bus 31 is converted from a PCI transaction into a platform by PCI I/F 303 of IOC 3, and sent through control circuit 302 and MMC_I/F 301 to MMC 16.

MMC 16 refers to cache tag 1602 and performs a cache coherency control process. After performing writeback from the store-in cache in each CPU, if necessary, MMC 16 accesses main memory device 17 (if MMC 16 accesses main memory device 27, then the transaction is routed to MMC 26). Data read from main memory device 17 is routed from MMC 16 through the reversed path to IOC 3 and sent to the I/O device which is the reading transaction issuance source.

(7) I/O device writing data in memory:

Data from an I/O device governed by a PCI bus can be written into a main memory device in substantially the same sequence as with the above process of reading data from the main memory device.

For an I/O device governed by PCI bus 31 to write data into main memory device 17, for example, a writing transaction and write data sent from the I/O device to PCI bus 31 are converted from a PCI transaction into a platform by PCI_I/F 303 of IOC 3, and sent through control circuit 302 and MMC_I/F 301 to MMC 16.

MMC 16 refers to cache tag 1602 and performs a cache coherency control process. After performing writeback from the store-in cache in each CPU, if necessary, MMC 16 writes the data into main memory device 17 if the write data destination is main memory device 17. Then, the processing sequence for the transaction is finished. If the write data destination is main memory device 27, then the transaction is transferred to MMC 26, and MMC 26 writes the write data into main memory device 27.

In recent years, there have been developed many multiprocessor systems. FIG. 1 shows a computer apparatus having a eight-way processor configuration. There have also been developed computer apparatus with more processors and I/O devices connected, e.g., computer apparatus having 32 or 64 processors or more than 100 I/O bus slots. Such large-scale computer apparatus are often used in mission-critical applications and hence need to maintain high availability.

In the above conventional computer apparatus with MMCs, however, if an IOC connected to an I/O device suffers a failure, then since no reply is returned in response to a transaction that is issued from a processor to the I/O device, the processor is unable to detect the failure of the IOC and stalls.

In the event of a processor stall due to an IOC fault, the computer apparatus detects timeout and may go down depending on the architecture thereof.

### SUMMARY OF THE INVENTION

It is an object of the present invention to provide a computer apparatus having a processor, a main memory device, a plurality of I/O devices, and a memory controller and an I/O controller for connecting those components, the computer apparatus being capable of continued operation in the even of a failure of the I/O controller.

To achieve the above object, a memory controller according to the present invention has a link monitoring circuit for detecting a communication cutoff between the memory controller and an I/O controller, and an error reply generating circuit for generating an error reply for a transaction being processed when the communication cutoff is detected. When the I/O controller is disconnected due to a fault, the memory controller, rather than the I/O controller, generates an error reply, for a transaction being processed which is addressed to an I/O device governed by the I/O controller, and sends the error reply to a transaction issuance source.

With a computer apparatus and a computer system incorporating the above memory controller, even if a reply for a transaction being processed cannot be returned due to a fault of the I/O controller, the memory controller, rather than the I/O controller, returns an error reply to the transaction issuance source. Consequently, even when the I/O controller fails to operate continuously, the I/O controller and an I/O bus governed thereby can be disconnected to allow the computer apparatus and the computer system to operate continuously.

At the time the memory controller detects a communication cutoff between the memory controller and the I/O controller, the memory controller generates an error reply and returns the error reply to the processor as the transaction issuance source. Therefore, when the I/O controller fails to operate continuously, the processor can recognize an I/O device fault prior to timeout due to waiting for a reply from an I/O device governed by the I/O controller. Accordingly, the processor is capable of performing an appropriate fault processing sequence.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of an arrangement of a conventional computer apparatus;

FIG. 2 is a block diagram of a conventional memory controller in the computer apparatus shown in FIG. 1;

FIG. 3 is a block diagram of a conventional I/O controller in the computer apparatus shown in FIG. 1;

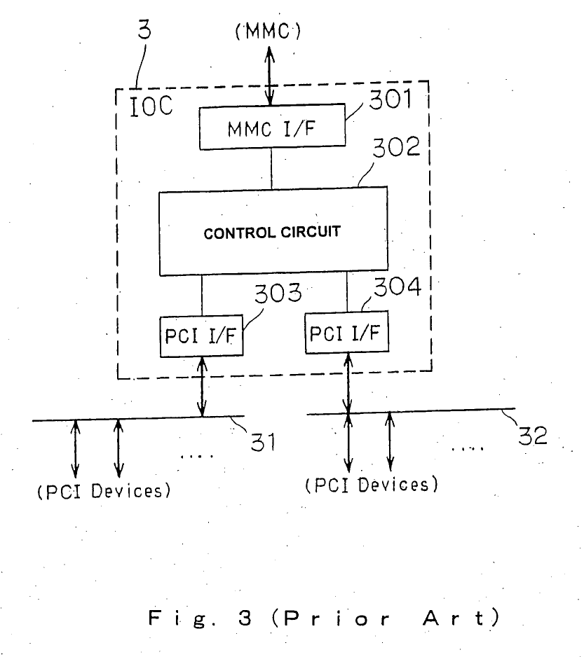

FIG. 4 is a block diagram of a memory controller according to a first embodiment of the present invention, for use in a computer apparatus according to the present invention;

FIG. 5 is a block diagram of a memory controller according to a second embodiment of the present invention, for use in the computer apparatus according to the present invention; and

FIG. 6 is a block diagram of a memory controller according to a third embodiment of the present invention, for use in the computer apparatus according to the present invention.

### DETAILED DESCRIPTION OF THE PREFERRED EMBODIMENTS

### 1st Embodiment

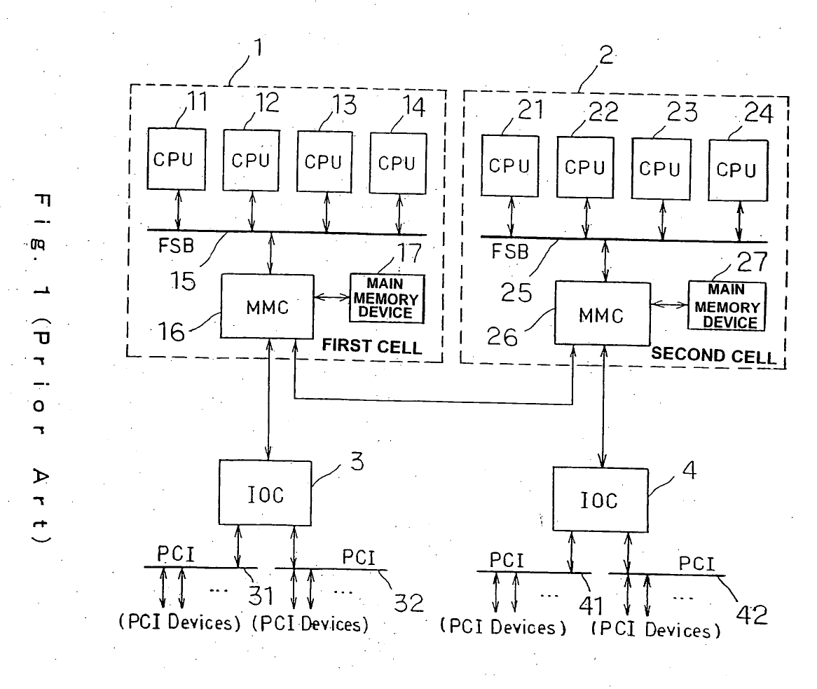

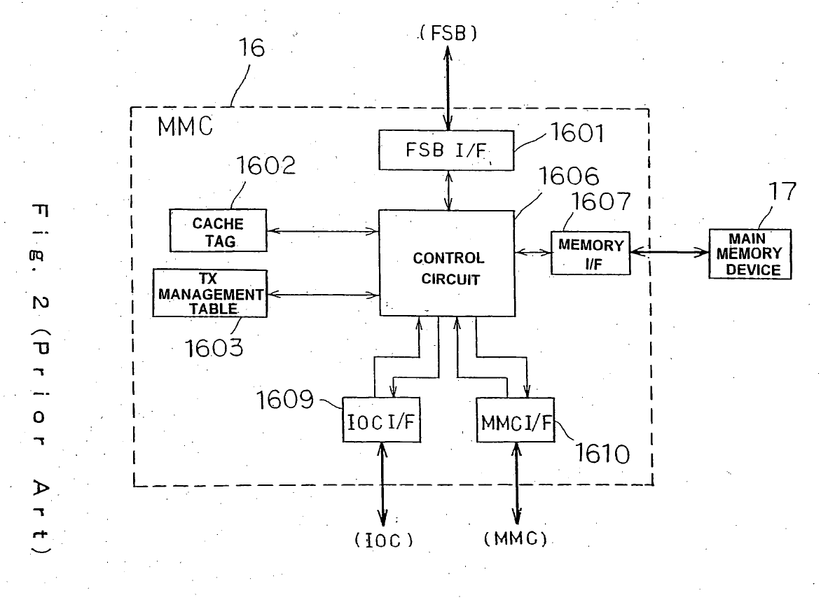

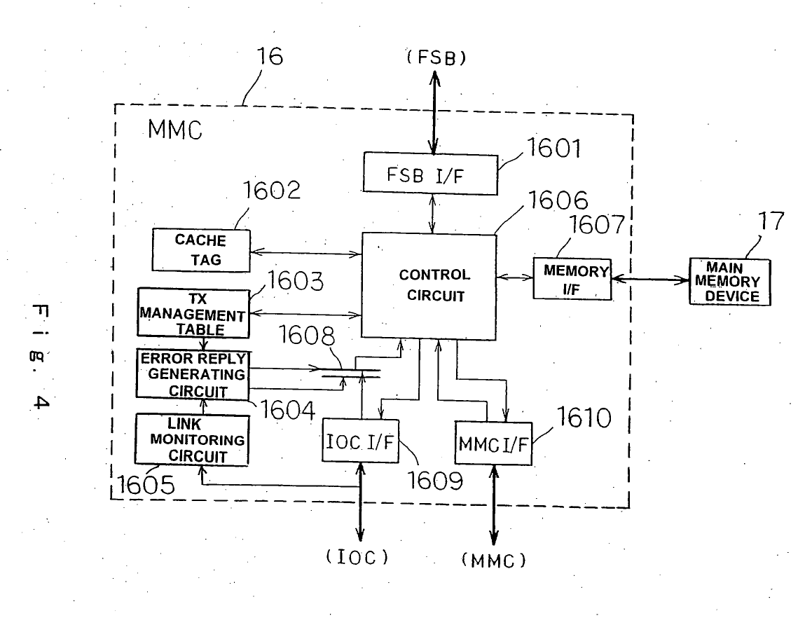

FIG. 4 is a block diagram of a memory controller according to a first embodiment of the present invention, for use in a computer apparatus according to the present invention. The memory controller shown in FIG. 4 is used as MMC 16 shown in FIG. 1. The memory controller shown in FIG. 4 may also be used as MMC 26 shown in FIG. 1. Other details of the computer apparatus according to the present invention and IOCs combined therewith are identical to those of the conventional computer apparatus, and will not be described in detail below. Those components shown in FIG. 4 which are identical to those shown in FIG. 2 are denoted by identical reference characters.

As shown in FIG. 4, the memory controller according to the first embodiment, hereinafter referred to as MMC 16, has FSB_I/F 1601 as an interface for FSB 15, memory I/F 1607 as an interface for a memory controller for controlling access to main memory device 17, IOC_I/F 1609 as an interface for IOC 3, MMC_I/F 1610 as an interface for the MMC of another cell, control circuit 1606 for performing a routing process on transactions sent and received between l/Fs, cache tag 1602 for storing copies of the tags of store-in caches in the CPUs, TX management table 1603 for storing header information, etc. corresponding to transactions that need to be replied, error reply generating circuit 1604 for generating an error reply for a transaction which is being processed when a communication cutoff occurs between MMC 16 and IOC 3, link monitoring circuit 1605 for detecting a communication cutoff between MMC 16 and IOC 3 and posting the detected communication cutoff to error reply generating circuit 1604, and selector 1608 for outputting either one of transactions sent from IOC_I/F 1609 and error reply generating circuit 1604 to control circuit 1606 according to a selection signal generated by error reply generating circuit 1604.

Link monitoring circuit 1605 monitors operation of IOC_I/F 1609 to detect a communication cutoff between MMC 16 and IOC 3. However, monitoring operation of IOC_I/F 1609 is not the only way to detect a communication cutoff between MMC 16 and IOC 3. If a signal indicative of the establishment of a link is sent and received between IOC 3 and MMC 16, then the signal may be monitored to detect a communication cutoff between MMC 16 and IOC 3. Alternatively, it may be monitored whether there is a transaction issued from MMC 16 to IOC 3 or not, and a communication cutoff may be judged as occurring between MMC 16 and IOC 3 if there is no transaction issued from MMC 16 to IOC 3 for a predetermined period of time. Further alternatively, OC 3 may have a function to post a failure, and may post a detected failure to MMC 16.

Error reply generating circuit 1604 remains inactive as long as the computer apparatus operates normally. Error reply generating circuit 1604 is activated when it receives a communication cutoff message from link monitoring circuit 1605. When error reply generating circuit 1604 is activated, it successively searches the entries registered in TX management table 1603. If error reply generating circuit 1604 detects a transaction being processed which is addressed to an I/O device connected to IOC 3 that is suffering the communication failure, then error reply generating circuit 1604 generates an error reply for the transaction and sends the error reply to selector 1608. Error reply generating circuit 1604 also sends a selection signal to cause selector 1608 to select the generated error reply.

While the computer apparatus is in normal operation, selector 1608 selects a transaction sent from IOC_I/F 1609 and outputs the transaction to control circuit 1606. In the event of a failure of IOC 3, selector 1608 outputs an error reply generated by error reply generating circuit 1604 to control circuit 1606 according to an instruction from error reply generating circuit 1604.

Operation of MMC 16 according to the first embodiment shown in FIG. 4 will be described below.

While the computer apparatus is operating normally, selector 1608 outputs a transaction sent from IOC_I/F 1609 to control circuit 1606 at all times. At this time, MMC 16 operates in the same manner as with the conventional MMC described above.

If PCI bus 31 or PIC bus 32 suffers a fault and cannot be operated continuously, then when control circuit 302 of IOC 3 detects a failure to send a transaction to PCI bus 31 or PIC bus 32, control circuit 302 shuts off PCI_I/F 303 or PCI_I/F 304 connected to the PCI bus, thereby disconnecting faulty PCI bus 31 or 32. The fault of PCI bus 31 or 32 includes a fault of an I/O device connected to PCI bus 31 or 32 and a fault of PCI_I/F 303 or 304 of IOC 3.

If IOC 3 has been receiving a transaction which requires a reply, then control circuit 302 of IOC 3 performs the following process depending on the source which issues the transaction:

If the transaction issuance source is a CPU, then control circuit 302 of IOC 3 returns an error reply, rather than an ordinary reply, to the CPU which has issued the transaction addressed to the disconnected PCI bus, irrespective of whether the transaction is being processed or is received after the PCI bus is disconnected. At this time, control circuit 302 of IOC 3 does not receive a reply from disconnected PCI bus 31 or 32.

If the transaction issuance source is an I/O device connected to the PCI bus, then control circuit 302 of IOC 3 does not receive a new transaction from the disconnected PCI bus. If control circuit 302 of IOC 3 receives a reply for the transaction being processed when the PCI bus is disconnected, through MMC 16 from a CPU, control circuit 302 discards the reply.

Operation of MMC 16 at the time of a communication cutoff between MMC 16 and IOC 3 will be described below.

If MMC_I/F 303 or control circuit 302 of IOC 3 suffers a failure, making it impossible for IOC 3 to operate continuously, then MMC 16 cuts off communications with IOC 3 because the interface for IOC 3 cannot be used.

After the communication cutoff, no reply is returned for a transaction being processed which is sent from CPU 11 to an I/O device, and the processing of the transaction is interrupted. MMC 16 does not receive a reply for a transaction being processed when IOC 3 is disconnected, from IOC 3, and does not receive a new transaction from an I/O device as a transaction issuance source.

When IOC_I/F 1609 is shut off due to a failure of IOC 3 or the like, link monitoring circuit 1605 of MMC 16 detects a communication cutoff between MMC 16 and IOC 3. Subsequently, though MMC 16 keeps sending a transaction addressed to IOC 3 which is newly received from a processor to IOC_I/F 1609, the transaction is not received by IOC 3 and is discarded. At this time, control circuit 1606 registers entries of a transaction which needs a reply in TX management table 1603 in the same manner as when the computer apparatus is in normal operation.

When link monitoring circuit 1605 detects a communication cutoff between MMC 16 and IOC 3, link monitoring circuit 1605 posts the communication cutoff to error reply generating circuit 1604. When error reply generating circuit 1604 receives the communication cutoff message, it sends a selection signal to selector 1608 to change paths to output a transaction generated by error reply generating circuit 1604 to control circuit 1606.

Then, error reply generating circuit 1604 successively refers to the entries registered in TX management table 1603 to locate entries corresponding to the transaction addressed to IOC 3. If those entries are found, then error reply generating circuit 1604 generates an error reply for the transaction, and sends the error reply through selector 1608 to control circuit 1606.

When control circuit 1606 receives the error reply, it deletes the corresponding entries from TX management table 1603, and sends the error reply to the processor as the transaction issuance source according to the same routing process as with error replies in normal operation. Even while the transaction is being processed or after the entries corresponding to the transaction addressed to OC 3 are deleted from TX management table 1603, a transaction may be sent through FSB_I/F 1601 or MMC_I/F 1610 and new entries may be registered in TX management table 1603. Therefore, error reply generating circuit 1604 continuously searches the entries in TX management table 1603 even after the entries corresponding to the transaction addressed to IOC 3 are deleted from TX management table 1603.

According to the first embodiment, link monitoring circuit 1605 monitors operation of IOC_I/F 1609 to detect a communication cutoff between MMC 16 and IOC 3, and error reply generating circuit 1604 generates an error reply for a transaction being processed which is addressed to IOC 3 and sends the error reply to a processor which issues the transaction. Therefore, the processor can detect a failure of IOC 3 before the computer apparatus goes down due to continued waiting for a reply for the transaction. The computer apparatus can continue its operation by disabling IOC 3.

### 2nd Embodiment

A memory controller according to a second embodiment of the present invention is arranged such that all transactions sent and received between an MMC and an IOC and between an MMC and an MMC are transmitted through a known crossbar system. The crossbar system is a technology well known to those skilled in the art, and will not be described in detail below.

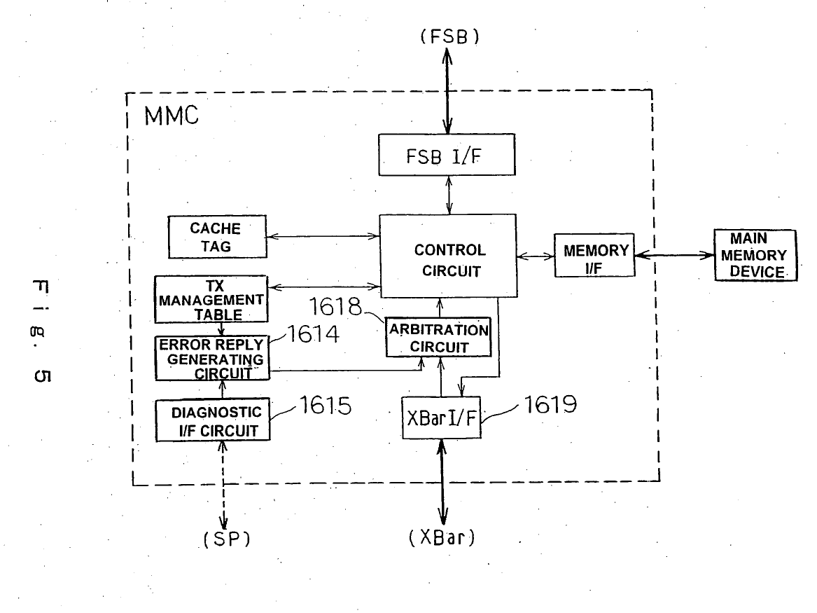

FIG. 5 is a block diagram of a memory controller according to a second embodiment of the present invention, for use in the computer apparatus according to the present invention.

As shown in FIG. 5, the MMC according to the second embodiment has error reply generating circuit 1614 for generating an error reply, XBar_I/F 1619 as an interface for a crossbar system, arbitration circuit 1618 for arbitrating a transaction generated by error reply generating circuit 1614 and a transaction received through XBar_I/F 1619, and diagnostic I/F circuit 1615 for performing a process subsequent to the detection of a communication cutoff according to an instruction from a service processor (not shown), all in place of IOC_I/F 1609, MMC_I/F 1610, selector 1608, error reply generating circuit 1604, and link monitoring circuit 1605 which are shown in FIG. 4.

The computer apparatus according to the second embodiment has XBar_I/F 1619 as a unified interface between the MMC and an IOC and between the MMC and another MMC.

Diagnostic I/F circuit 1615 is connected to the non-illustrated service processor (SP). When diagnostic I/F circuit 1615 is notified of an IOC failure from the service processor, diagnostic I/F circuit 1615 performs the same process as the process which is performed by the link monitoring circuit according to the first embodiment after the detection of a communication cutoff, using error reply generating circuit 1614 and arbitration circuit 1618.

Specifically, when diagnostic I/F circuit 1615 is notified of an IOC failure from the service processor, diagnostic I/F circuit 1615 posts the IOC failure information to error reply generating circuit 1614. When error reply generating circuit 1614 receives the IOC failure information, it successively searches the entries registered in the TX management table. If error reply generating circuit 1614 detects a transaction being processed which is addressed to the IOC, then error reply generating circuit 1614 generates an error reply for the transaction and sends the error reply to arbitration circuit 1618. Error reply generating circuit 1614 also sends a selection signal to arbitration circuit 1618 to select the generated error reply.

Arbitration circuit 1618 arbitrates a transaction generated by error reply generating circuit 1614 and a transaction received through XBar_I/F 1619. If the transactions have arrived simultaneously, arbitration circuit 1618 holds either one of the transactions and outputs the other transaction to the control circuit. Specifically, while the computer apparatus is in normal operation, arbitration circuit 1618 selects a transaction received through XBar_I/F 1619 and outputs the selected transaction to the control circuit. When the computer apparatus suffers an IOC failure, arbitration circuit 1618 selects and outputs an error reply generated by error reply generating circuit 1614 to the control circuit according to the selection signal from error reply generating circuit 1614.

The service processor is an apparatus having a processor independent of the computer apparatus shown in FIG. 1. The service processor collects fault information detected by LSI circuits and units of the computer apparatus while it is in operation, and shuts off and restarts the computer apparatus according to the collected fault information. The service processor is connected to the LSI circuits and the units by dedicated buses (diagnostic buses). Other structural and operational details of the MMC according to the second embodiment are identical to those of the MMC according to the first embodiment, and will not be described in detail below.

Operation of the MMC according to the second embodiment will be described below. Operation of the MMC according to the second embodiment while the computer apparatus is in normal operation is the same as operation of the MMC according to the first embodiment, and will not be described in detail below.

If an IOC (not shown) suffers a serious failure and cannot operate continuously, then when the IOC detects the failure, it shuts down itself and posts IOC fault information to the service processor.

When the service processor receives the IOC fault information, the service processor posts the IOC fault information through diagnostic buses to diagnostic I/F circuits 1615 of all the MMCs of the computer apparatus.

Even after the IOC failure, the control circuit of the MMC keeps sending a newly received transaction addressed to the IOC through the crossbar system to the IOC. However, the transaction is not received by the IOC and is discarded. When the control circuit of the MMC receives a transaction that requires a reply, the control circuit registers corresponding entries in the TX management table as when the computer apparatus is in normal operation.

Upon reception of the IOC fault information from the service processor, diagnostic I/F circuit 1615 posts a message indicative of the IOC that is shut off by the failure to error reply generating circuit 1614 at the time of the reception of the IOC fault information.

Error reply generating circuit 1614 refers to the entries registered in the TX management table, and successively searches the entries corresponding to a transaction being processed which is addressed to the faulty IOC. When error reply generating circuit 1614 detects the corresponding entries, it generates an error reply for the transaction, and sends the error reply through arbitration circuit 1618 to the control circuit.

When the control circuit of the MMC receives the error reply, it deletes the corresponding entries from the TX management table, and sends the error reply to the CPU as the transaction issuance source according to the same routing process as with error replies in normal operation. Even while the transaction is being processed or after the entries corresponding to the transaction addressed to the IOC are deleted from the TX management table, error reply generating circuit 1614 continuously searches the entries corresponding to a transaction addressed to the IOC in the TX management table, as with the first embodiment.

With the computer apparatus shown in FIG. 1, the number of terminals of LSI circuits and units of the MMCs and IOCs cannot be increased due to packaging limitations, posing limitations on the number of cells and the number of I/O devices that can be accommodated in the computer apparatus. According to the second embodiment, since the known crossbar system provides a combined interface between an MMC and an IOC and the MMC and another MMC, the above limitations are eliminated, allowing a larger-scale computer apparatus to be constructed.

### 3rd Embodiment

According to a third embodiment, a computer system is constructed of a plurality of computer apparatus (hereinafter referred to as nodes) each shown in FIG. 1. All I/O devices governed by each of the nodes are commonly used by the processors of the nodes.

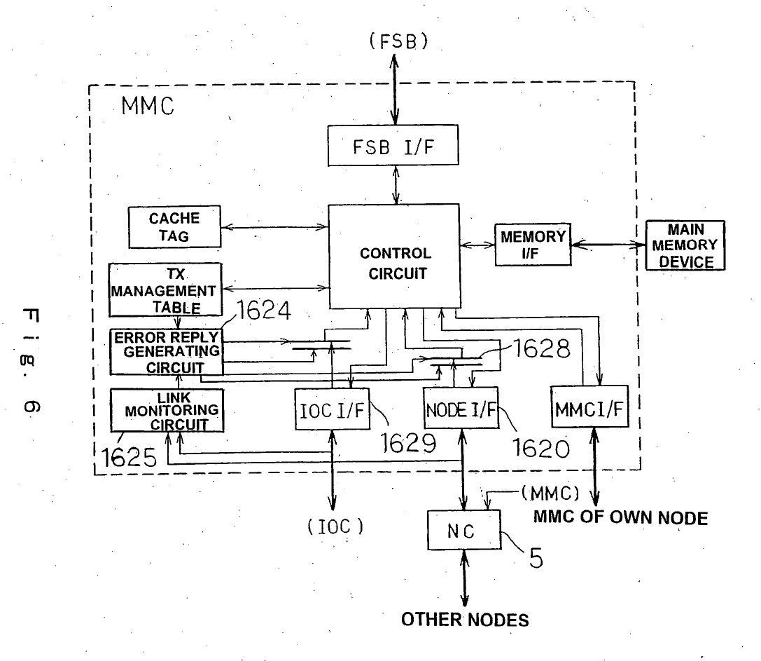

FIG. 6 is a block diagram of a memory controller according to a third embodiment of the present invention, for use in the computer apparatus according to the present invention.

As shown in FIG. 6, the MMC of the computer system according to the third embodiment has, in addition to the components of the MMC according to the first embodiment shown in FIG. 4, NODE_I/F 1620 as an interface for receiving and sending transactions between the control circuit and other nodes, and node selector 1628 for outputting either one of transactions sent from NODE_I/F 1620 and error reply generating circuit 1624 to the control circuit according to a selection signal generated by error reply generating circuit 1624.

The nodes are connected to each other for sending and receiving transactions therebetween, by node connection interfaces (NC) 5 that are associated with the respective nodes.

Link monitoring circuit 1625 according to the third embodiment monitors operation of IOC_I/F 1629 and NODE_I/F 1620, and detects a communication cutoff between IOC_I/F 1629 and the IOC of its own node and a communication cutoff between NODE_I/F 1620 and another node.

When error reply generating circuit 1624 receives a communication cutoff message from NODE_I/F 1620, it sends a selection signal to node selector 1628 to change paths to output a transaction generated by error reply generating circuit 1624 to the control circuit. Error reply generating circuit 1624 successively refers to the entries registered in the TX management table to locate entries corresponding to the transaction addressed another node. If those entries are found, then error reply generating circuit 1624 generates an error reply for the transaction, and sends the error reply through node selector 1628 to the control circuit. Other structural and operational details of the computer system are identical to those of the computer apparatus according to the first embodiment, and will not be described in detail below.

The MMC of each of the nodes may of the same arrangement as the MMC according to the second embodiment. In this case, a crossbar system provides a combined interface between the MMC and the IOC, between MMCs, and between the MMC and the NC, and the service processor may post a fault occurring in another node to the diagnostic I/F circuit.

According to the third embodiment, it is possible to construct a large-scale computer system of a plurality of computer apparatus according to the first and second embodiments. As with the first embodiment, even when an IOC fails to operate continuously, the IOC and an IOC bus governed thereby may be disconnected to allow the computer system to operate continuously.

While preferred embodiments of the present invention have been described using specific terms, such description is for illustrative purposes only, and it is to be understood that changes and variations may be made without departing from the spirit or scope of the following claims.

1. A computer apparatus comprising:
a plurality of cells each having a processor, a main memory device, and a memory controller for connecting said processor and said main memory device to each other;
a plurality of I/O buses associated respectively with said cells for connection to a plurality of peripheral devices; and
a plurality of I/O controllers for connecting the memory controllers of said cells and said I/O buses to each other;
said memory controller comprising:
a link monitoring circuit for detecting a communication cutoff between the memory controller and the I/O controller corresponding thereto;
an error reply generating circuit for receiving a message indicative of a detected communication cutoff from said link monitoring circuit, and generating an error reply for a transaction being processed which is issued from said processor to one of said peripheral devices;
a selector for outputting a reply sent from one of the peripheral devices through the I/O controller corresponding thereto while the computer apparatus is in normal operation, and outputting the error reply generated by said error reply generating circuit when the communication cutoff is detected; and
a control circuit for sending the reply or the error reply received from said selector to the corresponding processor as a source for issuing said transaction.

2. A computer apparatus comprising:
a plurality of cells each having a processor, a main memory device, and a memory controller for connecting said processor and said main memory device to each other;
a plurality of I/O buses associated respectively with said cells for connection to a plurality of peripheral devices;
a plurality of I/O controllers for connecting the memory controllers of said cells and said I/O buses to each other; and
a service processor having a processor independent of said cells, for collecting fault information detected by LSI circuits and units;
said memory controller comprising:
a diagnostic I/F circuit for receiving fault information of said I/O controllers which is collected by said service processor;
an error reply generating circuit for receiving the fault information of said I/O controllers from said diagnostic I/F circuit, and generating an error reply for a transaction being processed which is issued from said processor to one of said peripheral devices;
an arbitration circuit for outputting a reply sent from one of the peripheral devices through the I/O controller corresponding thereto while the computer apparatus is in normal operation, and outputting the error reply generated by said error reply generating circuit when the I/O controller suffers a failure; and
a control circuit for sending the reply or the error reply received from said arbitration circuit to the corresponding processor as a source for issuing said transaction.

3. The computer apparatus according to claim 2, wherein the memory controllers and the I/O controllers are connected to each other, and the memory controllers of said cells are connected to each other by a crossbar system.

4. A computer system comprising:
a plurality of computer apparatus each according to claim 1, said computer apparatus being connected to each other by a node connection interface capable of sending and receiving transactions therebetween;
wherein each of the memory controllers has a node selector for outputting a reply sent from another one of the computer apparatus through said node connection interface to said control circuit when the computer apparatus is in normal operation, and outputting the error reply sent from said error reply generating circuit to said control circuit when a communication cutoff is detected with respect to another one of the computer apparatus; and
said link monitoring circuit detects a communication cutoff with respect to the I/O controller and a communication cutoff with respect to another one of the computer apparatus.

5. A computer system comprising:
a plurality of computer apparatus each according to claim 2, said computer apparatus being connected to each other by a node connection interface capable of sending and receiving transactions therebetween;
wherein the arbitration circuit of each of the memory controllers outputs a reply sent from another one of the computer apparatus through said node connection interface to said control circuit when the computer apparatus is in normal operation, and outputs the error reply sent from said error reply generating circuit to said control circuit when said other one of the computer apparatus suffers a failure.

6. A memory controller for use in a computer apparatus comprising a plurality of cells each having a processor and a main memory device, said memory controller being capable of connecting said processor and said main memory device to each other and being connected to an I/O bus to which a plurality of peripheral devices are connectable, through an I/O controller, said memory controller comprising:
a link monitoring circuit for detecting a communication cutoff between the memory controller and the I/O controller;
an error reply generating circuit for receiving a message indicative of a detected communication cutoff from said link monitoring circuit, and generating an error reply for a transaction being processed which is issued from said processor to one of said peripheral devices;
a selector for outputting a reply sent from one of the peripheral devices through the I/O controller while the computer apparatus is in normal operation, and outputting the error reply generated by said error reply generating circuit when the communication cutoff is detected; and
a control circuit for sending the reply or the error reply received from said selector to the corresponding processor as a source for issuing said transaction.

7. A memory controller for use in a computer apparatus comprising a plurality of cells each having a processor and a main memory device, and a service processor having a processor independent of said cells, for collecting fault information detected by LSI circuits and units, said memory controller being capable of connecting said processor and said main memory device to each other and being connected to an I/O bus to which a plurality of peripheral devices are connectable, through an I/O controller, said memory controller comprising:
a diagnostic I/F circuit for receiving fault information of said I/O controller which is collected by said service processor;
an error reply generating circuit for receiving the fault information of said I/O controller from said diagnostic I/F circuit, and generating an error reply for a transaction being processed which is issued from said processor to one of said peripheral devices;
an arbitration circuit for outputting a reply sent from one of the peripheral devices through the I/O controller while the computer apparatus is in normal operation, and outputting the error reply generated by said error reply generating circuit when the I/O controller suffers a failure; and
a control circuit for sending the reply or the error reply received from said arbitration circuit to the corresponding processor as a source for issuing said transaction.

8. The memory controller according to claim 7, wherein the memory controller and the I/O controller are connected to each other, and the memory controllers of said cells are connected to each other by a crossbar system.
